(19) United States
(12) Patent Application Publication
(10) Pub. No.: US 2025/0222898 A1
(43) Pub. Date: Jul. 10, 2025

(54) METHOD OF ENHANCING SMART KEY SECURITY FOR A VEHICLE

(71) Applicants: HYUNDAI MOTOR COMPANY, Seoul (KR); KIA CORPORATION, Seoul (KR)

(72) Inventor: A-Ram Cho, Hwaseong-si (KR)

(73) Assignees: HYUNDAI MOTOR COMPANY, Seoul (KR); KIA CORPORATION, Seoul (KR)

(21) Appl. No.: 18/951,036

(22) Filed: Nov. 18, 2024

(30) Foreign Application Priority Data
Jan. 9, 2024 (KR) 10-2024-0003452

(51) Int. Cl. B60R 25/24; G07C 9/00

(52) U.S. Cl. CPC B60R 25/241; G07C 9/00309; G07C 2009/00412

(57) ABSTRACT

A method to enhance security of a vehicle against theft includes; receiving, by a diagnostic device, a customer personal information number (PIN) code for smart key registration; verifying, by a vehicle integrated controller, the validity of the customer PIN code; and encrypting and storing, by the vehicle integrated controller, the customer PIN code according to a result of the verification of the customer PIN code. The method further includes: displaying, by the diagnostic device, whether the smart key registration is completed according to a result of the storing of the customer PIN code.

### CROSS-REFERENCE TO RELATED APPLICATION

This application claims priority to Korean Patent Application No. 10-2024-0003452 filed on Jan. 9, 2024, which is incorporated herein by reference in its entirety.

### BACKGROUND

### Field of the Disclosure

The present disclosure relates to smart key registration technology and, more particularly, to a method of enhancing smart key security for a vehicle.

### Related Art

Vehicle theft is on the rise worldwide in a variety of ways. Particularly in Europe and India, there is a growing trend of stealing vehicles through a personal information number (PIN) code for key registration, which is secret information assigned to each individual vehicle.

In general, when a vehicle smart key (or a key fob) is lost, a new smart key should be registered through a service center. To register, a driver may either visit the service center in person or use an emergency roadside assistance to request a new or additional smart key.

In this case, the service center may determine whether a requester is a rightful owner of the vehicle by means of an identification (ID) card, a vehicle registration certificate, a short message service (SMS) authentication, and the like. When the requester is confirmed to be the rightful owner as a result of the determination, the service center may provide the requester with a 6-digit personal information number (PIN) code assigned to each vehicle for a new smart key registration. The following smart key registration is then performed using the provided PIN code and a dedicated diagnostic device for a registration service.

However, such the registration method relies on the security of the PIN code. Therefore, there are an increasing number of cases where vehicles have been stolen by obtaining a leaked PIN code in various manners or by obtaining a PIN code through separate access to a controller of the vehicle and then using a separate diagnostic device.

In addition, the registration may rely on the security of the original equipment manufacturer (OEM) pin code, but it is probable that such the OEM pin code may be leaked in various manners.

The statements in this Background section merely provide background information related to the present disclosure and may not constitute prior art.

### SUMMARY

An objective of the present disclosure is to provide a method to enhance security of a vehicle against theft of the vehicle.

Another objective of the present disclosure is to provide a method to enhance security of a vehicle using another PIN code in addition to an OEM PIN code.

To realize at least one of the above-described objectives, the present disclosure provides a method to enhance security of a vehicle to prevent theft of the vehicle.

In one embodiment of the present disclosure, a method of enhancing smart key security includes: receiving, by a diagnostic device, a customer personal information number (PIN) code for a smart key registration; verifying, by a vehicle integrated controller, validity of the customer PIN code; encrypting and storing, by the vehicle integrated controller, the customer PIN code according to a result of verifying the validity of the customer PIN code; and displaying, by the diagnostic device, whether the smart key registration is completed based on a result of the storing of the customer PIN code.

In one embodiment, receiving the customer PIN code may include: transmitting, by the diagnostic device, customer PIN code entry request information to a logic processing module of the vehicle integrated controller to request the customer PIN code be entered; transmitting, by the logic processing module, the customer PIN code entry request information to a security processing module of the vehicle integrated controller; confirming, by the security processing module, customer PIN code assignment information assigned for the customer PIN code based on the customer PIN code entry request information; and transmitting, by the security processing module, response information to the diagnostic device via the logic processing module.

Receiving the customer PIN code may include: displaying, by the diagnostic device, a user interface (UI) allowing the customer PIN code to be entered based on the response information; and transmitting, by the diagnostic device, the customer PIN code entered via the user interface to the logic processing module.

Encrypting and storing the customer PIN code may include: performing, by the logic processing module, validation for the entered customer PIN code; providing, by the logic processing module, the security processing module with an encryption request based on a result of the validation; generating, by the security processing module, an encryption key for the entered customer PIN code in response to the encryption request; and returning, by the security processing module, the encryption key to the logic processing module to store the encryption key therein.

Performing the validation may include determining whether the entered customer PIN code is a PIN code having at least a predetermined number of digits and including two or more characters.

The entered customer PIN code may include an initially entered customer PIN code and a re-entered customer PIN code.

Performing the validation may include determining whether a value of the initially entered customer PIN code matches a value of the re-entered customer PIN code.

The customer PIN code assignment information may be information representing a customer PIN code assignment state including an initial state in which the customer PIN code is not assigned and a key registered state in which the customer PIN code is assigned.

The customer PIN code assignment information may not be returned to the initial state after the customer PIN coded assignment information is recorded as the key registered state.

According to another embodiment of the present disclosure, a method of enhancing smart key security for a vehicle may include: receiving, by a diagnostic device, a customer personal information number (PIN) code for smart key registration; receiving, by the diagnostic device, driver specific information for authentication; performing, by a vehicle integrated controller, an authentication using the driver specific information; verifying, by the vehicle integrated controller, validity of the customer PIN code based on a result of the authentication; encrypting and storing, by the vehicle integrated controller, the customer PIN code based on a result of verifying the validity of the customer PIN code; and displaying, by the diagnostic device, whether the smart key registration is completed based on a result of the storing of the customer PIN code.

The driver specific information may include at least one of an original equipment manufacturer (OEM) PIN code, a vehicle identification number (VIN), ordering customer information, or a combination thereof.

The driver specific information may include a portion of a serial VIN.

Performing the authentication may include: transmitting, by the diagnostic device, the driver specific information to a logic processing module of the vehicle integrated controller; transmitting, by the logic processing module, the driver specific information and a pre-stored default value to a security processing module of the vehicle integrated controller; verifying, by the security processing module, equality on the driver specific information and the default value; and transmitting, by the security processing module, a result of verifying the equality to the diagnostic device via the logic processing module.

Receiving the driver specific information for authentication may include: displaying, by the diagnostic device, a user interface (UI) allowing the OEM PIN code to be entered; and transmitting, by the diagnostic device, the OEM PIN code entered via the user interface to the logic processing module.

When a value of the OEM PIN code and a value of a default OEM PIN code are the same, the security processing module transmits a positive response to the logic processing module.

When a value of the OEM PIN code and a value of a default OEM PIN code are different, the security processing module transmits a negative response to the logic processing module.

The default value may include a value stored to correspond to the driver specific information at the time of initial vehicle production.

According to still another embodiment of the present disclosure, a method of enhancing smart key security for a vehicle may include: after a initially entered customer personal information number (PIN) code for smart key registration is generated, receiving, by a diagnostic device, the initially entered customer PIN code in response to a customer PIN code change request from a driver; verifying, by a vehicle integrated controller, equality on the initially entered customer PIN code and a pre-stored customer PIN code in response to the customer PIN code change request; receiving, by the diagnostic device, a re-entered customer PIN code based on a result of verifying the equality; verifying, by the vehicle integrated controller, validity of the re-entered customer PIN code; encrypting and storing, by the vehicle integrated controller, the re-entered customer PIN code based on a result of verifying the validity of the re-entered customer PIN code; and displaying, by the diagnostic device, whether the smart key registration is completed based on a result of the storing of the re-entered customer PIN code.

Receiving the initially entered customer PIN code may include: transmitting, by the diagnostic device, customer PIN code entry request information to a logic processing module of the vehicle integrated controller in response to the customer PIN code change request from the driver; transmitting, by the logic processing module, the customer PIN code entry request information to a security processing module of the vehicle integrated controller; confirming, by the security processing module, customer PIN code assignment information assigned for the initially entered customer PIN code based on the customer PIN code entry request information; and transmitting, by the security processing module, response information to the diagnostic device via the logic processing module.

Verifying the equality may include: when values of the initially entered customer PIN code and the pre-stored customer PIN code are the same, transmitting, by the security processing module, a positive response to the diagnostic device via the logic processing module; and when the values of the initially entered customer PIN code and the customer PIN code stored are not the same, transmitting, by the security processing module, a negative response to the diagnostic device via the logic processing module.

When the diagnostic device receives a positive response, the diagnostic device receives a new customer PIN code different from the initially entered customer PIN code, and when the diagnostic device receives a negative response, the diagnostic device terminates a customer PIN code changing process.

According to the present disclosure, security for a vehicle may be enhanced against theft of the vehicle.

Another effect of the present disclosure is to enhance security for a vehicle using another customer PIN code in addition to the OEM PIN code.

### BRIEF DESCRIPTION OF THE DRAWINGS

FIG. 1 is a conceptual diagram illustrating a smart key security system according to an embodiment of the present disclosure.

FIG. 2 is a block diagram illustrating a specific configuration of the diagnostic device shown in FIG. 1 according to an embodiment of the present disclosure.

FIG. 3 is a block diagram illustrating a specific configuration of the vehicle shown in FIG. 2 according to an embodiment of the present disclosure.

FIG. 4 is a block diagram illustrating a specific configuration of the vehicle integrated controller shown in FIG. 3 according to an embodiment of the present disclosure.

FIG. 5 is a flow diagram illustrating a smart key registration process based on a customer personal information number (PIN) code entry method according to an embodiment of the present disclosure.

FIG. 6 is a flow diagram illustrating a smart key registration process based on an original equipment manufacturer (OEM) PIN code entry method according to an embodiment of the present disclosure.

FIG. 7 is a flow diagram illustrating a smart key registration process based on a vehicle identification number (VIN) entry method according to another embodiment of the present disclosure.

FIG. 8 is a flow diagram illustrating a smart key registration process based on an ordering customer information entry method according to another embodiment of the present disclosure.

FIG. 9 is a flow diagram illustrating a customer PIN code changing process according to an embodiment of the present disclosure.

The drawings described herein are for illustration purposes only and are not intended to limit the scope of the present disclosure in any way.

### DETAILED DESCRIPTION

The above and other objects, features and advantages of the present disclosure are described below in detail with reference to the accompanying drawings, and thus the technical spirit of the present disclosure can be easily implemented by those having ordinary skill in the art. In the following description of the present disclosure, if a detailed description of known configurations and functions is determined to obscure the interpretation of the present disclosure, the detailed description thereof has been omitted.

When a component, unit, module, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, embodiments according to the present disclosure are described in detail with reference to the accompanying drawings. In the drawings, the same reference numerals refer to the same or similar elements throughout.

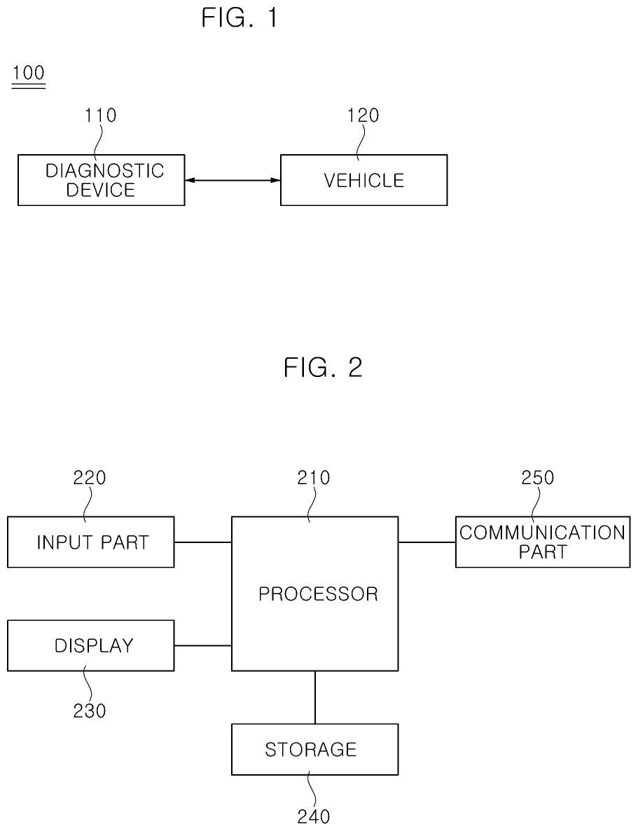

FIG. 1 is a conceptual diagram illustrating a smart key security system 100 according to an embodiment of the present disclosure. Referring to FIG. 1, a smart key security system 100 may include a diagnostic device 110 configured to generate a personal information number (PIN) code to register a smart key, a vehicle 120 connected to the diagnostic device 110 via communication and configured to register the smart key via the PIN code, and the like.

FIG. 2 is a block diagram illustrating a specific configuration of the diagnostic device 110 shown in FIG. 1. Referring to FIG. 2, the diagnostic device 110 may include a processor 210, an input part 220, a display 230, a storage 240, a communication part 250, and the like.

The processor 210 may perform a process for registering the smart key. Thus, the processor 210 may perform a function of entering and changing a customer PIN code. For this purpose, the processor 210 may exchange data and signals with the components.

The input part 220 may perform a function of receiving commands from a driver (or a user). Accordingly, the input part 220 may be an operation key, a touchscreen, a microphone, and the like, and a combination thereof. The input part 220 may also function as a display using a touchscreen.

The display 230 may perform a function of outputting a menu screen, a setting screen, processing data, notification information, and the like. The menu screen may include smart key state information for checking the current smart key, smart key registration for registering the smart key, and the like. Accordingly, the display 230 may be configured to include a display, a sound system, and the like. The display may be a liquid crystal display (LCD), a light-emitting diode (LED) display, an organic LED (OLED) display, a touchscreen, a flexible display, or the like. The touchscreen may be a touch component, in which case the touchscreen may serve as both an input means and an output means.

The storage 240 may perform a function of storing a program having an algorithm for executing a process for registering a smart key, related data, and processing data, and the like. For this purpose, the storage 240 may include a combination of a flash memory disk (e.g., solid state disk (SSD)), a hard disk drive, a flash memory, a non-volatile memory, such as electrically erasable programmable read-only memory (EEPROM), static RAM (SRAM), ferro-electric RAM (FRAM), phase-change RAM (PRAM), and magnetic RAM (MRAM), and/or a volatile memory, such as dynamic random access memory (DRAM), synchronous dynamic random access memory (SDRAM), and double data rate-SDRAM (DDR-SDRAM).

The communication part 250 may perform a function of being connected to the vehicle 120 via communication. For this purpose, the communication part 250 may be configured to include a communication modem, a microprocessor, a communication circuit, and the like. The diagnostic device 110 and the vehicle 120 may perform communication using an on-board diagnostics (OBD)-II interface or the like.

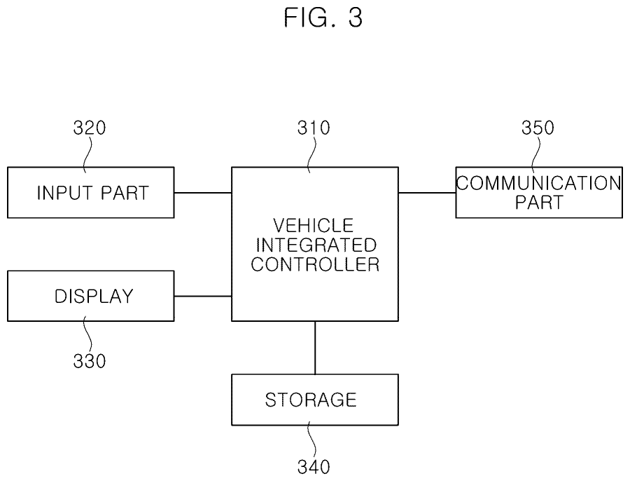

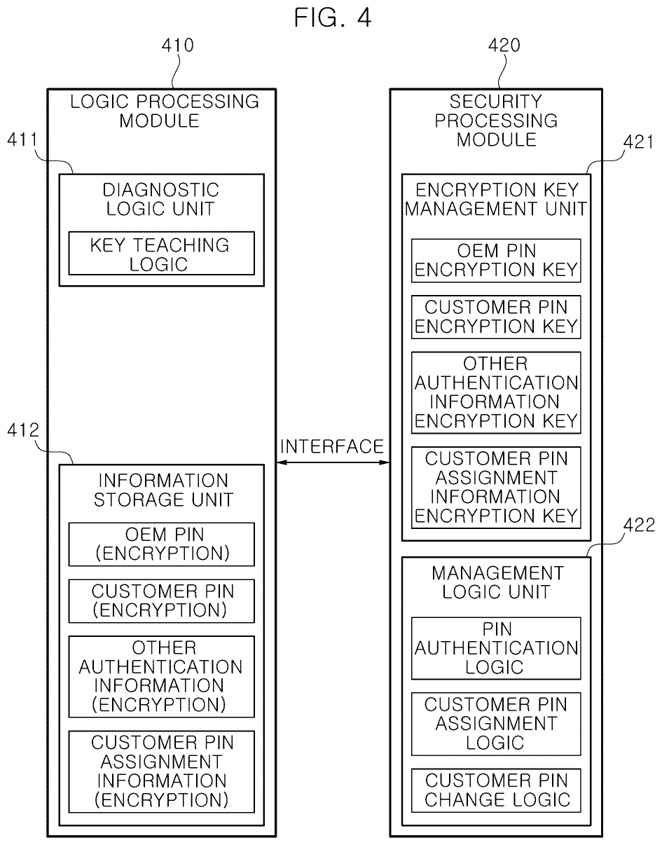

FIG. 3 is a block diagram illustrating a specific configuration of the vehicle 120 shown in FIG. 2. Referring to FIG. 3, the vehicle 120 may include a vehicle integrated controller 310, an input part 320, a display 330, a storage 340, a communication part 350, and the like.

The vehicle integrated controller 310 may perform a function of receiving and processing a smart key registration request from the diagnostic device 110. In particular, the vehicle integrated controller 310 may verify the validity of the customer PIN code transmitted by the diagnostic device 110 for smart key registration and encrypt and store the customer PIN code according to the result of the verification.

The input part 320, the display 330, the storage 340, and the communication part 350 may be similar in function to the input part 220, the display 230, and the storage 240 shown in FIG. 2, and therefore descriptions thereof have been omitted.

FIG. 4 is a block diagram illustrating a specific configuration of the vehicle integrated controller 310 shown in FIG. 3. Referring to FIG. 4, the vehicle integrated controller 310 may include a logic processing module 410, a security processing module 420, and the like. The logic processing module 410 may include a diagnostic logic unit 411 configured to perform key teaching logic, an information storage unit 412 configured to store PIN code-related information, and the like.

The diagnostic logic unit 411 may perform key teaching logic on the PIN code transmitted from the diagnostic device 110. The key teaching logic may be logic to perform validation on the PIN code and, when the validation is successful, requests encryption for the PIN code.

The information storage unit 412 may function to store encryption key information generated by the security processing module 420. The encryption key information may include an original equipment manufacturing (OEM) PIN code encryption key, a customer PIN encryption key, an encryption key for other authentication information representing other authentication-related information, and a customer PIN code assignment information encryption key representing whether the customer assigns the PIN code. The customer PIN code assignment information encryption key may have one of the following values representing a customer PIN code assignment state:
\textcircled{1} Virgin (initial state): Customer PIN code is not assigned
\textcircled{2} Learnt (key registered state): Customer PIN code assigned

The customer PIN code assignment information may not be returned to the initial state Virgin once recorded as the key registered state Learnt. The initial state may be a new electronic control unit (ECU) state in which a transponder key is not unregistered and the ECU is unable to start. The key registered state may indicate that a properly registered transponder key is present.

The security processing module 420 may include an encryption key management unit 421 configured to manage encryption keys, a management logic unit 422 configured to manage PIN codes, and the like.

The encryption key management unit 421 may generate an encryption key for the corresponding PIN code from the diagnostic logic unit 411. Examples of the encryption key include an OEM encryption key, a customer PIN encryption key, an encryption key for other authentication information, a customer PIN assignment information encryption key, and the like.

The OEM PIN code, the customer PIN code, the other authentication information, the customer PIN code assignment information, and the like may be major security information and must be secure. Therefore, encryption keys may be generated within the hardware-based security processing module 420 to prevent such information from being publicly available in a decrypted state.

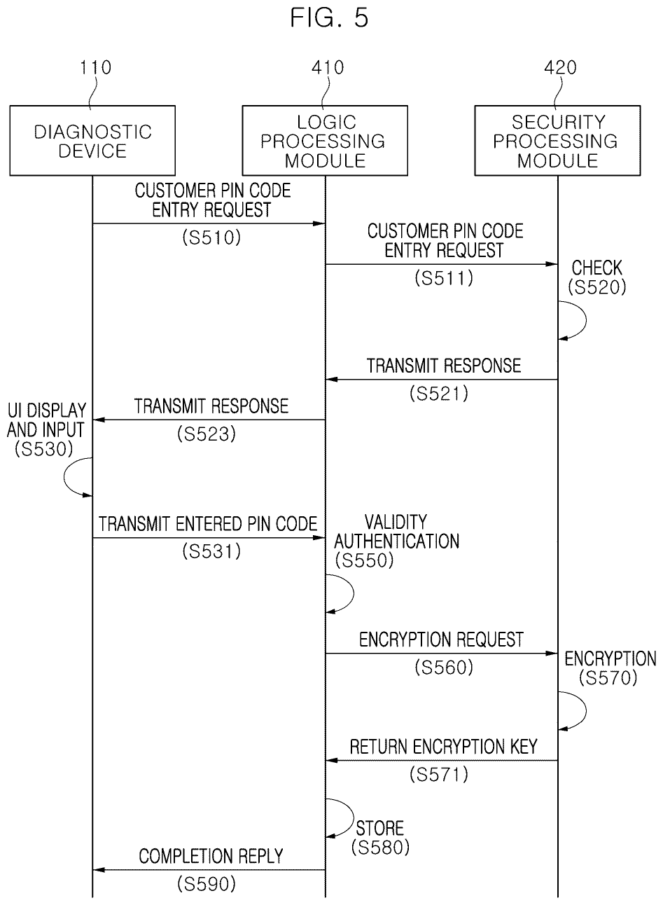

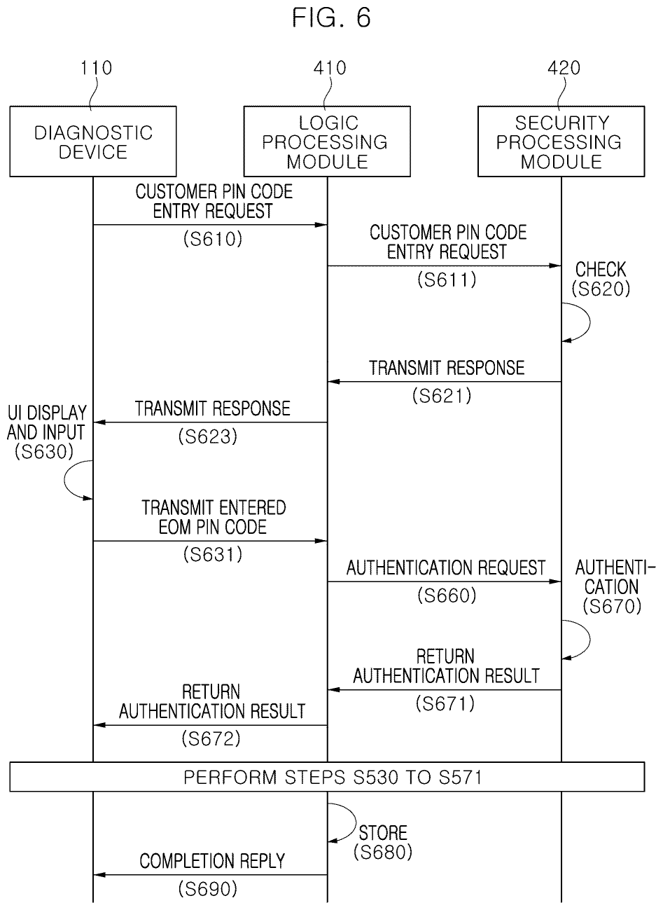

The management logic unit 422 may perform PIN authorization logic, customer PIN assignment logic, customer PIN change logic, and the like. The PIN authorization logic may be an algorithm to perform a PIN authentication function. The customer PIN assignment logic may be an algorithm to perform a customer PIN assignment function, and the customer PIN change logic may be an algorithm to perform a customer PIN change function. These algorithms are described with reference to FIGS. 5 and 6.

Referring to FIG. 4, the term “unit” in the drawings refers to a unit that performs at least one function or operation, which may be implemented in software and/or hardware. In hardware implementations, the “unit” may be implemented as an application specific integrated circuit (ASIC), a digital signal processor (DSP), a programmable logic device (PLD), a field programmable gate array (FPGA), a processor, a microprocessor, other electronic units designed to perform the functions described above, or any combination thereof.

In software implementation, the “unit” may include software composition components (elements), object-oriented software composition components, class composition components, task composition components, processes, functions, properties, procedures, subroutines, segments of program code, drivers, firmware, microcode, data, databases, data structures, tables, arrays, and variables. Software, data, and the like may be stored in memory and executed by a processor. The memory or processor may employ various means well known to those having ordinary skill in the art.

In the present disclosure, a customer PIN code entry method may include four types. Among such types, a first type illustrates in detail a key teaching process after registration of the customer PIN code. In other words, the same process as the existing key teaching process may be performed, but an authentication may be performed using a customer-entered PIN code rather than an OEM PIN code. The first type is illustrated in FIG. 5.

FIG. 5 is a flow diagram illustrating a smart key registration process based on a customer PIN code entry method according to an embodiment of the present disclosure. Referring to FIG. 5, when the driver requests the diagnostic device 110 to enter a customer PIN code, the diagnostic device 110 transmits customer PIN code entry request information to the logic processing module 410 (step S510).

The logic processing module 410 may transmit the received customer PIN code entry request information to the security processing module 420 (step S511). In other words, the diagnostic logic unit 411 of the logic processing module 410 may request the security processing module 420 to enter the customer PIN code.

Thereafter, the security processing module 420 may check the internally stored customer PIN assignment information according to the above entry request (step S520). In other words, the customer PIN assignment information may refer to pre-specified information for the customer PIN code. This may be specified by the driver or may be specified by a manufacturer when the vehicle is shipped from the factory.

Subsequently, in step S520, based on the result of the checking, the security processing module 420 may transmit response information to the logic processing module 410 (step S521). In other words, the logic processing module 410 may check the customer PIN assignment information and responds positively when the assignment information is not present or negatively when the assignment information is present.

Thereafter, the logic processing module 410 may transmit the response information to the diagnostic device 110 (step S523).

Subsequently, when the response information transmitted is positive, the diagnostic device 110 may display a user interface (UI) for entering the customer PIN code on the screen of the display 230. The user interface may be an interface between a user and a system and allows the user to easily view or enter information on the screen.

The driver may enter the customer PIN code twice through the user interface (step S530). The two entries may include an initial entry and a re-entry that confirms the initial entry. The entries may also include more than two entries.

When the entry is complete, the diagnostic device 110 may transmit the entered customer PIN code to the logic processing module 410 (step S531).

Thereafter, the logic processing module 410 may perform validation on the entered customer PIN code (step S550). The validation may determine whether the entered customer PIN code is a PIN code that is at least 10 digits long and includes at least two characters. Further, the validation may determine whether the values of the customer PIN code entered twice may be the same. Both or only one of the two validation methods may be performed.

This validation of whether the values are the same may ensure that a value of the initially entered customer PIN code generated by the initial entry and a value of the re-entry customer PIN code generated by the re-entry are the same, i.e., match to each other.

Subsequently, when the validation is successful, the logic processing module 410 may request that the entered customer PIN code be encrypted (step S560).

Thereafter, the security processing module 420 may encrypt the entered customer PIN code into a customer PIN encryption key having a random string value and return the customer PIN encryption key to the logic processing module 410 (steps S570 and S571).

Subsequently, the logic processing module 410 may store the customer PIN encryption key in the storage 340 via the information storage unit 412 (step S580).

Thereafter, the logic processing module 410 may reply to the diagnostic device 110 that the smart key registration is complete (step S590). In other words, when the smart key registration including the saving is normally completed, the logic processing module 410 may reply to the diagnostic device 110 that the smart key registration is normally completed. Thus, the diagnostic device 110 may indicate that the smart key registration is normally completed.

In step S530, when the diagnostic device 110 receives a negative response, the diagnostic device 110 may output on the user interface that it is unable to assign the customer PIN code.

A second type of the customer PIN code entry method may be to enter the customer PIN code based on an OEM PIN code entry authentication. In other words, in addition to the existing OEM PIN code authentication, the key teaching may be allowed only when the customer PIN code authentication is successful. The second type is illustrated in FIG. 6.

FIG. 6 is a flow diagram illustrating a smart key registration process based on an original equipment manufacturer (OEM) PIN code entry method according to an embodiment of the present disclosure. With reference to FIG. 6, the same applies to steps S610 to S623 as to steps S510 to S523 described with reference to FIG. 5. Therefore, descriptions thereof have been omitted.

Thereafter, when the response information transmitted is a positive response, the diagnostic device 110 may display on the screen of the display 230 a user interface allowing the OEM PIN code which is driver specific information to be entered. The driver may enter the OEM PIN code through the user interface (step S630).

When the entry is complete, the diagnostic device 110 may transmit the entered input OEM PIN code to the logic processing module 410 (step S631).

Subsequently, the logic processing module 410 may request an authentication by transmitting the entered OEM PIN code and a stored default value (i.e., a default OEM PIN code) encrypted and stored at the time of initial vehicle production to the security processing module 420 (step S660). In other words, the default OEM PIN code may be a value encrypted and stored at the time of initial vehicle production to correspond to the entered OEM PIN code.

Thereafter, the security processing module 420 may perform an authentication to determine whether the values of the entered OEM PIN code and the default OEM PIN code may be the same using comparison logic to determine whether the authentication is successful (step S670).

When it is determined whether the authentication is successful, the security processing module 420 may transmit the result of the authentication to the logic processing module 410 (step S671). In other words, when the values of the OEM PIN code and the default OEM PIN code are the same, the security processing module 420 may transmit a positive response to the logic processing module 410. In contrast, when the values of the OEM PIN code and the default OEM PIN code are not the same, the security processing module 420 may transmit a negative response to the diagnostic device 110 via the logic processing module 410 (steps S671 and S672).

Thereafter, when the response is positive, steps S530 to S571 shown in FIG. 5 are performed, and the customer PIN encryption key may be stored in the storage 340 via the information storage unit 412 (step S680).

Subsequently, the logic processing module 410 may reply to the diagnostic device 110 that the smart key registration is complete (step S690). In other words, when the smart key registration including the saving is normally completed, the logic processing module 410 may reply to the diagnostic device 110 that the smart key registration is normally completed.

In step S630, when the diagnostic device 110 receives a negative response, the diagnostic device 110 may output on the user interface that it is unable to assign the customer PIN code.

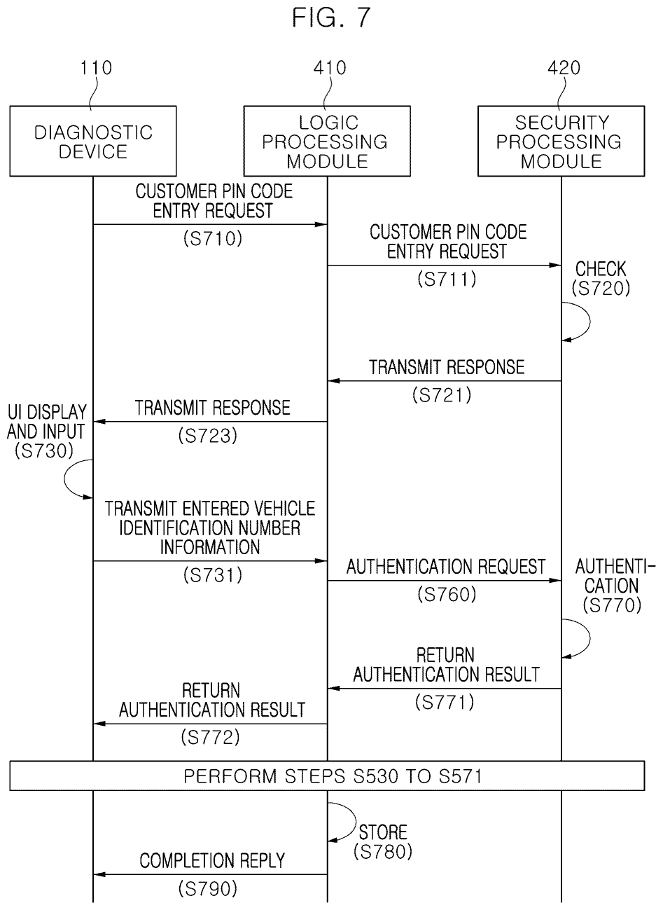

A third type of the customer PIN code entry method may be to enter the customer PIN code based on a vehicle identification number (VIN) entry authentication. In other words, when the customer PIN code is lost, the key teaching based on the OEM PIN code is allowed only after separate authentication equipment is used. The third type is illustrated in FIG. 7.

FIG. 7 is a flow diagram illustrating a smart key registration process based on a VIN entry method according to another embodiment of the present disclosure. Referring to FIG. 7, the same applies to steps S710 to S723 as to steps S510 to S523 described with reference to FIG. 5. Therefore, descriptions thereof have been omitted.

Thereafter, when the response information transmitted is positive, the diagnostic device 110 may display on the screen of the display 230 a user interface allowing a VIN which is driver specific information to be entered. The driver may enter the VIN through the user interface (step S730). For example, the driver enters six characters of the last string, i.e., a portion of the serial VIN as the driver specific information.

When the entry is complete, the diagnostic device 110 may transmit the entered VIN information (i.e., the entered character string) to the logic processing module 410 (step S731).

Thereafter, the logic processing module 410 may request an authentication by transmitting the entered VIN information and a stored default value (i.e., vehicle-related authentication information) encrypted and stored at the time of initial vehicle production to the security processing module 420 (step S760). In other words, the vehicle-related authentication information may be a value encrypted and stored at the time of initial vehicle production to correspond to the entered VIN information. Examples of the vehicle-related authentication information include a VIN, a vehicle unique identification number, and the like.

Subsequently, the security processing module 420 may perform an authentication using comparison logic to determine whether the values of the entered VIN information and the vehicle-related authentication information may be the same to determine whether the authentication is successful (step S770).

When it is determined whether the authentication is successful, the security processing module 420 may transmit the result of the authentication to the logic processing module 410 (step S771). In other words, when the values of the input VIN information and the vehicle-related authentication information are the same, the security processing module 420 may transmit a positive response to the logic processing module 410. In contrast, when the values of the input VIN information and the vehicle-related authentication information are not the same, the security processing module 420 may transmit a negative response to the diagnostic device 110 via the logic processing module 410 (steps S771 and S772).

Thereafter, when the response is positive, steps S530 to S571 shown in FIG. 5 are performed, and the customer PIN encryption key may be stored in the storage 340 via the information storage unit 412 (step S780).

Subsequently, the logic processing module 410 may reply to the diagnostic device 110 that the smart key registration is complete (step S790). In other words, when the smart key registration including the saving is normally completed, the logic processing module 410 may reply to the diagnostic device 110 that the smart key registration is normally completed.

In step S730, when the diagnostic device 110 receives a negative response, the diagnostic device 110 may output on the user interface that it is unable to assign the customer PIN code.

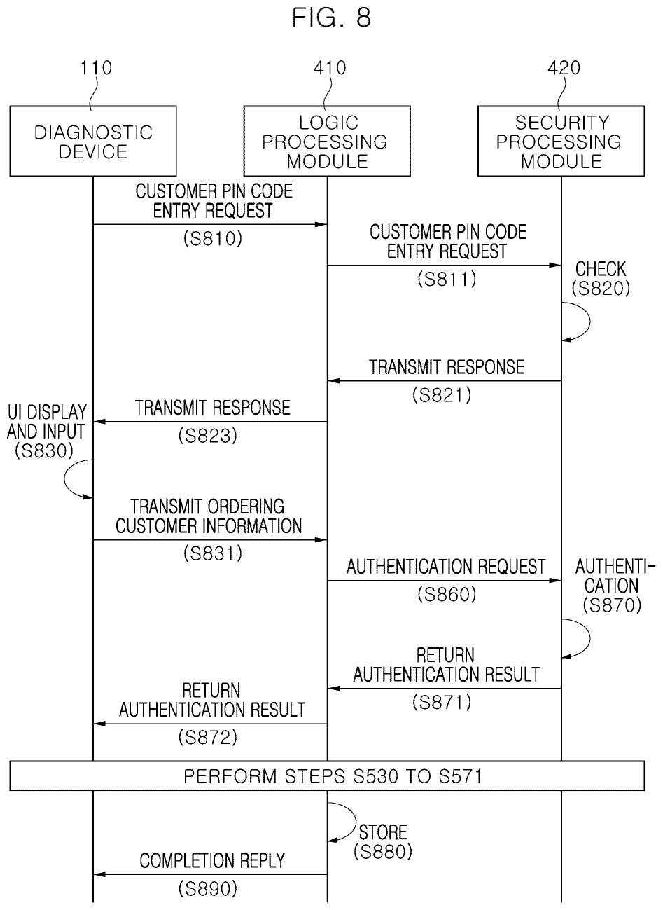

A fourth type of the customer PIN code entry method may be to enter the customer PIN code based on an ordering customer information authentication. The fourth type is illustrated in FIG. 8.

FIG. 8 is a flow diagram illustrating a smart key registration process based on an ordering customer information entry method according to another embodiment of the present disclosure. Referring to FIG. 8, the same applies to steps S810 to S823 as to steps S510 to S523 described with reference to FIG. 5. Therefore, descriptions thereof have been omitted.

Thereafter, when the response information transmitted is positive, the diagnostic device 110 may display on the screen of display 230 a user interface allowing the order customer information which is driver-specific information to be entered. The driver enters the ordering customer information through the user interface (step S830). For example, the ordering customer information may be a date of birth, a business license number, or other specified characters.

When the entry is complete, the diagnostic device 110 may transmit the entered ordering customer information (i.e., the entered character string) to the logic processing module 410 (step S831).

Subsequently, the logic processing module 410 may request an authentication by transmitting the entered ordering customer information and the stored default value encrypted at the time of initial vehicle production (i.e., the order-related authentication information) to the security processing module 420 (step S760). The order-related authentication information may be a value encrypted and stored at the time of initial vehicle production to correspond to the entered VIN information. The order-related authentication information may be, for example, a date of birth, a business license number, or other specified characters.

Thereafter, the security processing module 420 may perform an authentication to determine whether the values of the entered ordering customer information and the order-related authentication information are the same using comparison logic so as to determine whether the authentication is successful (step S870).

When it is determined whether the authentication is successful, the security processing module 420 may transmit the result of the authentication to the logic processing module 410 (step S871). In other words, when the values of the entered ordering customer information and the order-related authentication information are the same, the security processing module 420 may transmit a positive response to the logic processing module 410. In contrast, when the values of the entered ordering customer information and the order-related authentication information are not the same, the security processing module 420 may transmit a negative response to the diagnostic device 110 via the logic processing module 410 (steps S871 and S872).

Subsequently, when the response is positive, steps S530 to S571 shown in FIG. 5 are performed, and the customer PIN encryption key may be stored in the storage 340 via the information storage unit 412 (step S880).

Thereafter, the logic processing module 410 may reply to the diagnostic device 110 that the smart key registration is complete (step S890). In other words, when the smart key registration including the saving is normally completed, the logic processing module 410 may reply to the diagnostic device 110 that the smart key registration is normally completed.

In addition, in step S830, when the diagnostic device 110 receives a negative response, the diagnostic device 110 may output on the user interface that it is unable to assign the customer PIN code.

Basically, the key teaching process may use either the first type shown in FIG. 5 or the second type shown in FIG. 6.

However, in a situation where it is unable to authenticate the customer PIN code, a separate authentication may be performed based on the master key pre-input into the security processing module 420. In a case where the corresponding authentication is successful, even when the customer PIN code is assigned, the key teaching may be allowed by the OEM PIN code authentication alone.

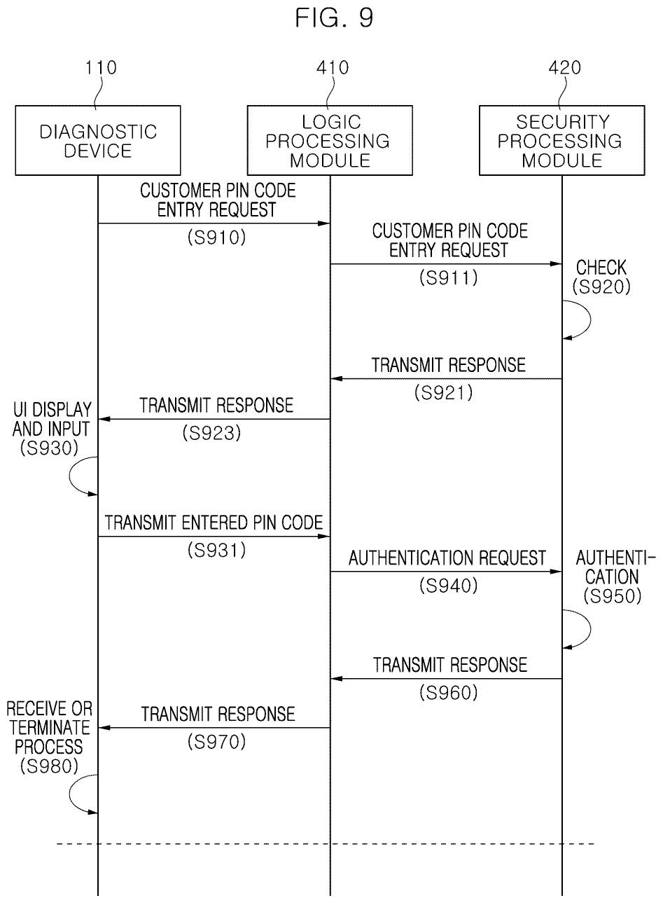

FIG. 9 is a flow diagram illustrating a customer PIN code changing process according to an embodiment of the present disclosure. Referring to FIG. 9, after the customer PIN code is initially entered as described with reference to FIGS. 5 to 8, the customer PIN code may be changed.

When the driver requests the diagnostic device 110 to change the customer PIN code, the diagnostic device 110 may transmit the customer PIN code change request information to the logic processing module 410 (step S910).

The logic processing module 410 may transmit the received customer PIN code change request information to the security processing module 420 (step S911). In other words, the diagnostic logic unit 411 of the logic processing module 410 may request the security processing module 420 to change the customer PIN code.

Thereafter, the security processing module 420 may check the internally stored customer PIN assignment information in response to the above change request (step S920). In other words, the customer PIN assignment information may refer to pre-assigned information for the customer PIN code. This may be assigned by the driver or by the manufacturer at the time that the vehicle is shipped.

Subsequently, in step S920, based on the result of the verification, the security processing module 420 may transmit response information to the logic processing module 410 (step S921). In other words, the logic processing module 410 may check the customer PIN assignment information and responds positively when the assignment information is present and negatively when the assignment information is not present.

Thereafter, the logic processing module 410 may transmit the response information to the diagnostic device 110 (step S923).

Subsequently, when the response information transmitted is positive, the diagnostic device 110 may display on the screen of the display 230 a user interface allowing the customer PIN code to be entered. The driver may enter an initially entered customer PIN code (i.e., an existing customer PIN code that has been previously entered, e.g., a first customer PIN code) through the user interface (step S930).

When the entry of the initially entered customer PIN code is complete, the diagnostic device 110 may transmit the entered initially entered customer PIN code to the logic processing module 410 (step S931).

Thereafter, the logic processing module 410 may request the security processing module 420 to perform an equality verification on the initially entered customer PIN code and the pre-stored customer PIN code (step S940).

The security processing module 420 may perform the equality verification on the values of the initially entered customer PIN code and the stored customer PIN code (step S950).

In step S950, when the values of the initially entered customer PIN code and the stored customer PIN code are the same as the result of the comparison, the security processing module 420 may transmit a positive response to the diagnostic device 110 via the logic processing module 410. In contrast, in step S950, when the values of the initially entered customer PIN code and the stored customer PIN code are not the same as the result of the comparison, the security processing module 420 may transmit a negative response to the diagnostic device 110 via the logic processing module 410.

Subsequently, when the diagnostic device 110 receives a positive response, the diagnostic device 110 may receive a re-entered customer PIN code (i.e., a new customer PIN code, e.g., a second customer PIN code) different from the initially entered customer PIN code (step S980). In this case, steps S530 to S590 illustrated in FIG. 5 are performed for the re-entered customer PIN code.

In another example, when the diagnostic device 110 receives a negative response, the diagnostic device 110 may terminate the process

In addition, the steps of the methods or algorithms described in connection with the embodiments disclosed hereinabove may be implemented in the form of program instructions executable by various computer means, such as a microprocessor, a processor, a central processing unit (CPU), or the like, for recording on a computer-readable medium. The computer-readable medium may include one or a combination of program (instruction) code, a data file, a data structure, and the like.

What is claimed is:

1. A method of enhancing smart key security for a vehicle, the method comprising:
receiving, by a diagnostic device, a customer personal information number (PIN) code for a smart key registration;
verifying, by a vehicle integrated controller, validity of the customer PIN code;
encrypting and storing, by the vehicle integrated controller, the customer PIN code based on a result of verifying the validity of the customer PIN code; and
displaying, by the diagnostic device, whether the smart key registration is completed based on a result of the storing of the customer PIN code.

2. The method of claim 1, wherein receiving the customer PIN code comprises:
transmitting, by the diagnostic device, customer PIN code entry request information to a logic processing module of the vehicle integrated controller to request the customer PIN code be entered;
transmitting, by the logic processing module, the customer PIN code entry request information to a security processing module of the vehicle integrated controller;
confirming, by the security processing module, customer PIN code assignment information assigned for the customer PIN code based on the customer PIN code entry request information; and
transmitting, by the security processing module, response information to the diagnostic device via the logic processing module.

3. The method of claim 2, wherein receiving the customer PIN code comprises:
displaying, by the diagnostic device, a user interface (UI) allowing the customer PIN code to be entered based on the response information; and
transmitting, by the diagnostic device, the customer PIN code entered via the user interface to the logic processing module.

4. The method of claim 3, wherein encrypting and storing the customer PIN code comprises:
performing, by the logic processing module, validation for the entered customer PIN code;
providing, by the logic processing module, the security processing module with an encryption request based on a result of the validation;
generating, by the security processing module, an encryption key for the entered customer PIN code in response to the encryption request; and
returning, by the security processing module, the encryption key to the logic processing module to store the encryption key therein.

5. The method of claim 4, wherein performing the validation comprises determining whether the entered customer PIN code is a PIN code having at least a predetermined number of digits and including two or more character.

6. The method of claim 4, wherein the entered customer PIN code comprises an initially entered customer PIN code and a re-entered customer PIN code.

7. The method of claim 6, wherein performing the validation comprises determining whether a value of the initially entered customer PIN code matches a value of the re-entered customer PIN code.

8. The method of claim 2, wherein the customer PIN code assignment information is information representing a customer PIN code assignment state including an initial state in which the customer PIN code is not assigned and a key registered state in which the customer PIN code is assigned, and
wherein the customer PIN code assignment information is not returned to the initial state after the customer PIN code assignment information is recorded as the key registered state.

9. A method of enhancing smart key security for a vehicle, the method comprising:
receiving, by a diagnostic device, a customer personal information number (PIN) code for smart key registration;
receiving, by the diagnostic device, driver specific information for authentication;
performing, by a vehicle integrated controller, an authentication using the driver specific information;
verifying, by the vehicle integrated controller, validity of the customer PIN code based on a result of the authentication;
encrypting and storing, by the vehicle integrated controller, the customer PIN code based on a result of verifying the validity of the customer PIN code; and
displaying, by the diagnostic device, whether the smart key registration is completed based on a result of the storing of the customer PIN code.

10. The method of claim 9, wherein the driver specific information includes at least one of an original equipment manufacturer (OEM) PIN code, a vehicle identification number (VIN), ordering customer information, or a combination thereof.

11. The method of claim 10, wherein the driver specific information includes a portion of a serial VIN.

12. The method of claim 10, wherein performing the authentication comprises:
transmitting, by the diagnostic device, the driver specific information to a logic processing module of the vehicle integrated controller;
transmitting, by the logic processing module, the driver specific information and a pre-stored default value to a security processing module of the vehicle integrated controller;
verifying, by the security processing module, equality on the driver specific information and the default value; and
transmitting, by the security processing module, a result of verifying the equality to the diagnostic device via the logic processing module.

13. The method of claim 12, wherein receiving the driver specific information for authentication comprises:
displaying, by the diagnostic device, a user interface (UI) allowing the OEM PIN code to be entered; and
transmitting, by the diagnostic device, the OEM PIN code entered via the user interface to the logic processing module.

14. The method of claim 13, further comprising: when a value of the OEM PIN code and a value of a default OEM PIN code are the same, transmitting, by the security processing module, a positive response to the logic processing module.

15. The method of claim 13, further comprising: when a value of the OEM PIN code and a value of a default OEM PIN code are different, transmitting, by the security processing module, a negative response to the logic processing module.

16. The method of claim 12, wherein the default value includes a value stored to correspond to the driver specific information at a time of initial vehicle production.

17. A method of enhancing smart key security for a vehicle, the method comprising:
after an initially entered customer personal information number (PIN) code for smart key registration is generated, receiving, by a diagnostic device, the initially entered customer PIN code in response to a customer PIN code change request from a driver;
verifying, by a vehicle integrated controller, equality on the initially entered customer PIN code and a pre-stored customer PIN code in response to the customer PIN code change request;
receiving, by the diagnostic device, a re-entered customer PIN code based on a result of verifying the equality;
verifying, by the vehicle integrated controller, validity of the re-entered customer PIN code;
encrypting and storing, by the vehicle integrated controller, the re-entered customer PIN code based on a result of verifying the validity of the re-entered customer PIN code; and
displaying, by the diagnostic device, whether the smart key registration is completed based on a result of the storing of the re-entered customer PIN code.

18. The method of claim 17, wherein receiving the initially entered customer PIN code comprises:
transmitting, by the diagnostic device, customer PIN code entry request information to a logic processing module of the vehicle integrated controller in response to the customer PIN code change request from the driver;
transmitting, by the logic processing module, the customer PIN code entry request information to a security processing module of the vehicle integrated controller;
confirming, by the security processing module, customer PIN code assignment information assigned for the initially entered customer PIN code based on the customer PIN code entry request information; and
transmitting, by the security processing module, response information to the diagnostic device via the logic processing module.

19. The method of claim 18, wherein verifying the equality comprises:
when values of the initially entered customer PIN code and the pre-stored customer PIN code are the same, transmitting, by the security processing module, a positive response to the diagnostic device via the logic processing module; and
when the values of the initially entered customer PIN code and the customer PIN code stored are not the same, transmitting, by the security processing module, a negative response to the diagnostic device via the logic processing module.

20. The method of claim 19, further comprising:
when the diagnostic device receives a positive response, receiving, by the diagnostic device, a new customer PIN code different from the initially entered customer PIN code; and
when the diagnostic device receives a negative response, terminating, by the diagnostic device, a customer PIN code changing process.
